(19) United States
(12) Patent Application Publication
(10) Pub. No.: US 2003/0040303 A1
(43) Pub. Date: Feb. 27, 2003

(54) System and method for providing and receiving sports-related information

(76) Inventors: David Nelson, Baltimore, MD (US); Debra Marie Nelson, Baltimore, MD (US)

Correspondence Address: Supervisor, Patent Prosecution Services, PIPER RUDNICK LLP, 1200 Nineteenth Street, N.W., Washington, DC, 20036-2412, US

(21) Appl. No.: 10/216,382

(22) Filed: Aug. 12, 2002

Related U.S. Application Data
(60) Provisional application No. 60/311,102, filed on Aug. 10, 2001.

(51) Int. Cl. H04B 1/38; H04M 3/42

(52) U.S. Cl. 455/414; 455/550

(57) ABSTRACT

A system and method for providing and receiving sports-related information, including scoring information, on a handheld or other device accessed by a user in a sporting arena. At least one handheld or other user device is made available at sporting arenas or elsewhere for users to access sports-related information. During a sporting event, a communication device provides the user device with original roster information, a disabled list, the weather forecast, general information about a particular sporting arena, and scoring information updates as the game progresses. The user is also able to enter, store, and later retrieve at least some of the sports-related information, such as scoring information, so that the user can review and analyze the scoring information for the sports event and games for an entire season.

This application claims priority from U.S. Provisional Application Serial No. 60/311,102 filed Aug. 10, 2001. The entirety of that provisional application is incorporated herein by reference.

### BACKGROUND OF THE INVENTION

1. Field of the Invention

The present invention generally relates to providing information on a handheld or other device, and more specifically relates to a system and method for providing sports-related information on a handheld or other device accessed by a user in a sporting arena.

2. Background of the Technology

Sporting event entities have recognized the benefit of allowing fans to interactively participate in sporting events. For example, many baseball games allow fans to keep track of scoring information on a paper scoring card. For example, paper baseball scoring cards are often used by fans. Sporting event entities have also incorporated technological advancements. For example, many games have big screen scoreboards or televisions that relate current game information to fans. Sporting events, however, can do more to incorporate technology in a manner that allows fans to interactively participate in games. There is thus a need for a system and method that allows fans to more interactively participate in sporting events.

### SUMMARY OF THE INVENTION

The present invention provides a handheld or other sports information device and method of use that allow fans to take advantage of current technology to better enjoy, and more interactively participate in sporting events.

In an embodiment of the present invention, at least one handheld or other device is made available at sporting arenas for sporting events (e.g., baseball games, football games, basketball games, soccer games, hockey games, golf matches, tennis matches, Olympic events) for users (e.g., fans, media), or is otherwise used by a user watching a sporting event. The handheld or other device allows the user, for example, to access sports-related information provided on the storage mechanism of the device or otherwise accessible by the device, and information provided via at least one communication device (e.g., transmitter/receiver), to provide a higher level of fan enjoyment and fan interaction with the game. For example, during a baseball game, a communication device at a remote location can provide the device, which is able to receive the communicated information, with original roster information, a disabled list, the weather forecast, general information about a particular sporting arena (e.g., emergency exits or food options and prices), and allow the user to receive scoring information updates as the game progresses. The user can also view sports-related information related to other sporting games (e.g., major and minor games).

In an alternative embodiment, the user is also able to enter information into the device that is communicated by a communication device in or coupled to the device. For example, the user can respond to a survey, or “keep score” on the device.

In an additional embodiment, the user has the option to save at least some of the sports-related information by utilizing a storage mechanism of the device or accessible by the device. For example, the user may save the sports-related information related to scoring and is able to retrieve the saved information, such as at a later time at a remote location, to recreate games for an entire season, make comparisons, and create alternate scenarios.

In one embodiment, the information can be provided in English or any other language. In another embodiment, the information can be provided in multiple languages for international or other events.

The present invention is described in terms of the above embodiments. This is for convenience only and is not intended to limit the application of the present invention. In fact, after reading the description of the present invention, it will be apparent to one skilled in the relevant arts how to implement the present invention in alternative embodiments.

### BRIEF DESCRIPTION OF THE FIGURES

Additional features and advantages of the present invention will become more apparent from the detailed description set forth below when taken in conjunction with the drawings in which like reference numbers indicate identical or functionally similar elements.

FIGS. 1 and 2 are pictograms of various system components, in accordance with an embodiment of the present invention.

FIG. 3 is a flow diagram of an overview of a method of operation, in accordance with an embodiment of the present invention.

FIGS. 4 is a flow diagram of an example method of operation, in accordance with an embodiment of the present invention.

FIGS. 5-9 are charts illustrating aspects of an example scoring system, in accordance with an embodiment of the present invention.

### DETAILED DESCRIPTION OF THE PRESENT INVENTION

The present invention provides a device and method of use that allow fans to take advantage of current technology to better enjoy, and more interactively participate in sporting events. For example, in an embodiment of the present invention, a handheld or other device is utilized by a user watching a baseball game. The handheld or other device allows the user to access and enter sports-related information. For example, a communication device at a remote location can provide the device with original roster information, a disabled list, the weather forecast, and general information about the particular baseball sporting arena. The user can also view sports-related information related to other major and minor league baseball games. The user is also able to enter scoring information on a play-by-play basis into the device, save this scoring information, and review this scoring information to recreate the baseball game, view a particular play's impact on the season, make comparisons, and create alternate scenarios.

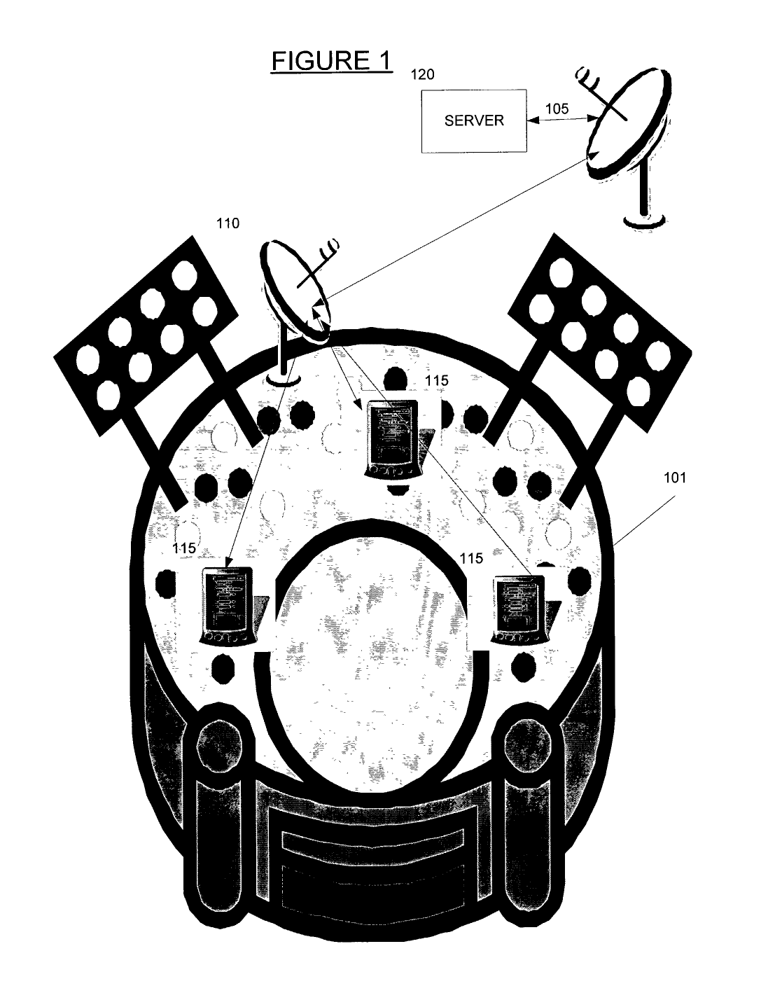

FIG. 1 is a pictogram of various system components, in accordance with an embodiment of the present invention. The system includes at least one communication device (105 or 110) coupled to a server 120, and at least one handheld or other user device 115 (e.g., Blackberry, Handspring, Palm Pilot, wireless telephone, device connected by wires to a network, any input device) used by the user with scorecard application software 120 and, including a repository, such as a storage mechanism located in or coupled to the handheld or other user device 115 or located within or coupled to the server 120. The couplings include, for example, wired, wireless, or fiber optic connections. In one embodiment, the user is physically attending the sporting event at the stadium 101. In another embodiment, the user is remote from the stadium 101, but able to interactively use the system of the present invention while viewing or otherwise following the sporting event. In one embodiment, two communication devices are used: a national/regional or other communication device 105 communicates information with a local stadium communication device 110, which communicates information to the handheld or other device 115. In an additional embodiment, additional communication devices are used. In other embodiments, the handheld or other user device 115 can be used with wired and/or wireless networks (e.g., user devices 115 can be attached to stadium seats, and connected via a wire network run by the stadium; user devices 115 can be used at the user's home via the Internet).

In an embodiment of the present invention, a handheld or other user device is made available at sporting arenas for sporting events (e.g., baseball games, football games, basketball games, golf games, tennis games, Olympic events) for users (e.g., fans, media). The communication device downloads or otherwise communicates information (e.g., via a network) from the handheld or other user device. In another embodiment, a user can access the sports-related information via a user-owned (as opposed to a rented or freely distributed handheld device) handheld or other user device. The handheld or other device allows the user to access sports-related information provided on the storage mechanism and provided by the communication devices to provide a higher level of fan enjoyment and fan interaction with the game.

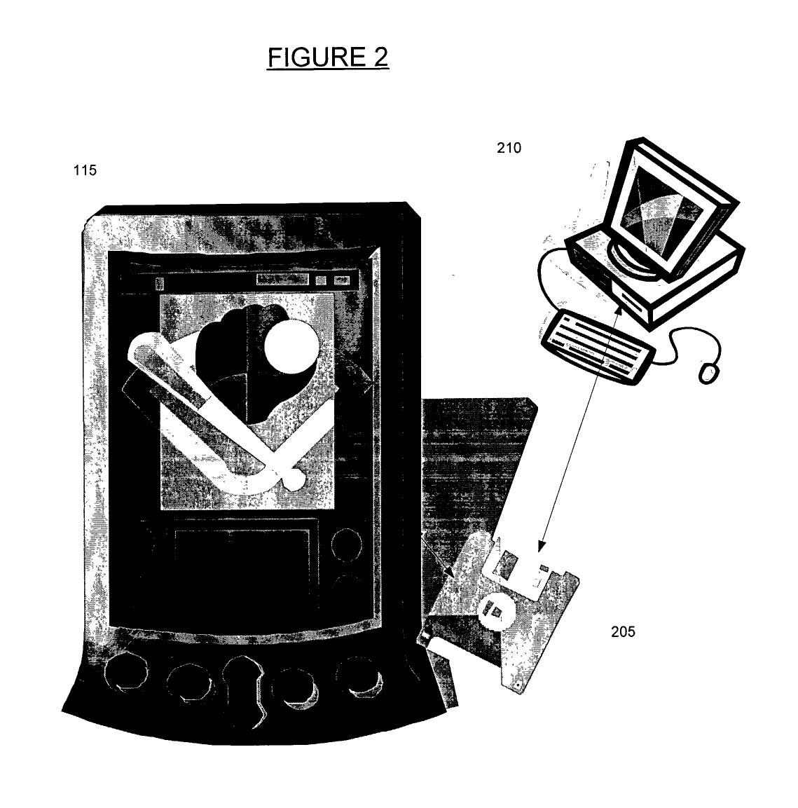

FIG. 2 is also a pictogram of various system components, in accordance with an embodiment of the present invention. As shown in FIG. 2, in one embodiment, the handheld or other user devices 115 include a storage mechanism 205 (e.g., computer disk, computer chip) that stores some of the sports-related information (e.g., score sheet results). The storage mechanism may be taken out of the handheld or other user device and downloaded to a remotely located access device, such as a terminal 210 (e.g., a storage mechanism on a home computer desktop). In this way, the sports-related information may be stored (e.g., for an entire sports season). In another embodiment, the user can obtain the stored sport-related information from a remote location by utilizing a Web site or other mechanism (e.g., by logging onto a Web site with a user identification (ID) and password). For example, in one embodiment, the user is able to save information via the hand-held or other device to the server 120, as shown in FIG. 1, and then the user accesses the stored information via a remote terminal on a network, such as the Internet, to which the server 120 is also coupled. In one embodiment, login information (e.g., user ID, password) is used to control user access to the handheld or other user device, as well as the stored sports-related information.

The sports-related information includes, but is not limited to, current game information regarding a game played at the sporting arena, other game information regarding at least one other game played at another sports arena (e.g., major league games, minor league games), and advertising information.

The current game information includes, but is not limited to, background information (e.g., season background on team performance) team roster information (e.g., original rosters, roster changes, disabled lists, future pitching rosters, player background information and statistics, team statistics), scoring information (e.g., updated scoring results), sporting arena information (e.g., emergency exit information, restroom location information, vender location information, weather information, policy information, first aid information, parking information, lost and found information, police information), and other sports-related information (e.g., future game schedules, promotions and giveaway information, announcements).

The other game information includes, but is not limited to, background information (e.g., season background), team roster information (e.g., original rosters, roster changes, disabled lists, future pitching rosters), scoring information (e.g., updated scoring results), and other sports-related information (e.g., future game schedules).

In an optional embodiment, the sports-related information includes at least one question (e.g., survey question, contest question, questions regarding the handheld or other user device's technical features, question regarding the sporting arena) for the user to ask or answer.

In another embodiment of the present invention, the sports-related information includes graphics and other presentation features to make the sports-related information device more interesting and exciting.

Method Overview

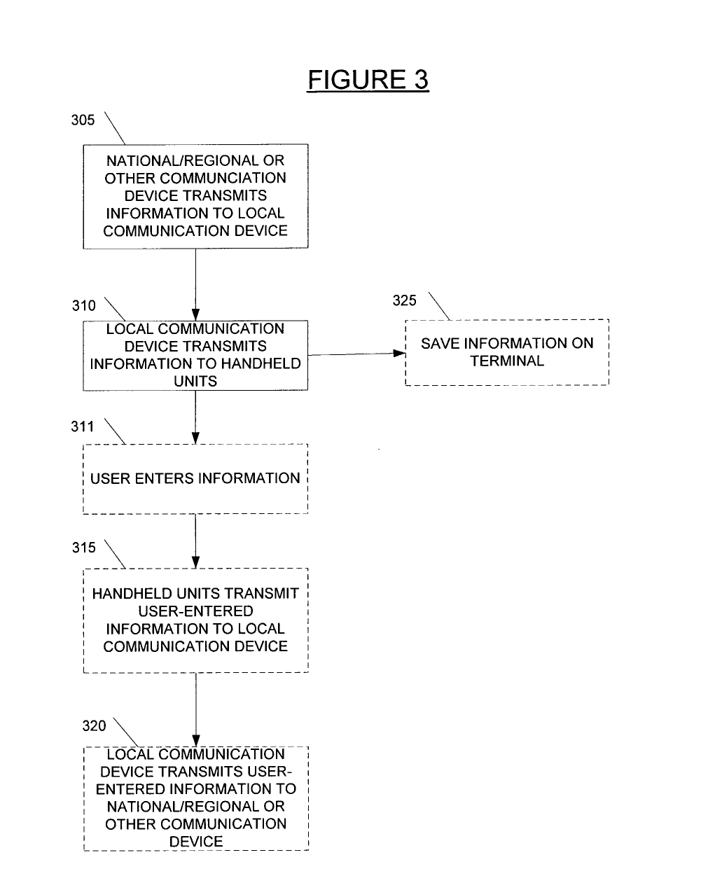

FIG. 3 is a flow diagram of an overview of a method of operation, in accordance with one embodiment of the present invention. In step 305, the national/regional or other communication device communicates sports-related information provided via a server to a local communication device. In step 310, the local communication device communicates the sports-related information to handheld or other user devices. In optional step 311, the user enters information into the handheld or other user device. In optional step 315, the handheld or other user devices communicate the user-entered sports-related information to the communication device. In optional step 320, the local communication device communicates the user-entered information back to a regional/national communication device for storage or access via a server.

In optional step 325, the user may save at least some of the sports-related information on a terminal by utilizing the storage mechanism of the device or by accessing the server on which the information is stored via, for example, a network, such as the Internet. For example, the user may save the sports-related information related to scoring. In an additional embodiment of the present invention, rather than receiving updated scoring information and saving the scoring information on terminal 210, the user is provided with the ability to keep score on the device in a manner similar to that used for a scoring sheet provided in a paper program (see, e.g., FIG. 9 and accompanying text below). The user may then save this information on a terminal by utilizing storage mechanism.

In one embodiment, the handheld or other devices, which include associated software, are rented or distributed for free at the sporting arena, similar to how a program is bought today at sporting arenas. In another embodiment, the user can access the server via a user-owned handheld or other device (e.g., a PDA).

Example Method

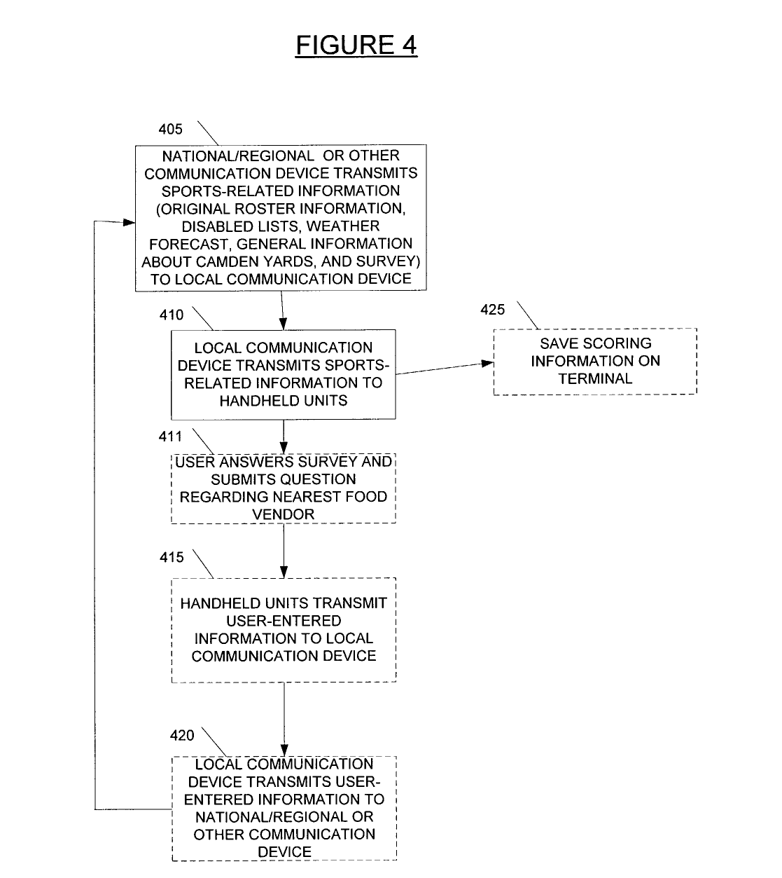

FIGS. 4 is a flow diagram of a second example method of operation, in accordance with an embodiment of the present invention. In step 405, the national communication device communicates sports-related information regarding a specific baseball game provided via a server to a local communication device located at the sporting arena. In step 410, the local communication device communicates the sports-related information to handheld or other user devices, which are accessed by users (e.g., fans, media) who have rented the handheld or other user devices from the sporting arena. The sports-related information includes the original roster information, a disabled list, the weather forecast, general information about the sporting arena, and a survey. The user also receives status updates of other professional sporting games (e.g., baseball games, football games) at other sporting arenas. The user accesses the handheld or other user device to receive updated score results. Alternatively, or additionally, in step 411, the user is able to enter information on the device. The user-entered information includes, for example, user-recorded scoring information, in which case the user “keeps score” on the device, similar to how scoring on a score sheet is maintained using a paper scoring sheet in a program. The user-entered information can also include, for example, other information useful to the system provided or stadium management, such as questions about the food choices of the sporting arena, for which responses are elicited via the handheld or other user device. As another example, the user-entered information can include responses to surveys.

In optional step 415, the handheld or other user device communicates at least some of the user information (e.g., the question and response to the survey, but not the user-recorded scoring information) to the local communication device. In optional step 420, the local communication device communicates the user information to the national communication device converted to the server, and a host operator accessing the server, for example, answers the user's question and utilizes the user's answer to the survey. Steps 405-420 can be repeated for other communications (e.g., to answer the user's question or provide additional updated roster information).

In optional step 425, the user may access at least some of the sports-related information via a terminal by utilizing the storage mechanism of the handheld or other user device or by accessing the server, such as via a network (e.g., the Internet). For example, the user may save the sports-related information related to scoring and is able to recreate games for an entire season, make comparisons, and create scenarios. For example, if a user downloaded to the user terminal score sheet information for an entire season of games, the user would be able to review these games by reviewing the scoring sheets. In addition, the user, for example, could review how different plays (e.g., striking out) impacted a game or a season, or use the scoring information in conjunction with simulation or other features.

In an additional embodiment of the present invention, rather than receiving updated score information, the user is provided with the ability to keep score on the device in a manner similar to that used for a scoring sheet provided in a paper program. The user may then access this information via a terminal and is able to review or recreate games for an entire season, make comparisons, and create scenarios.

Exemplary Scoring System

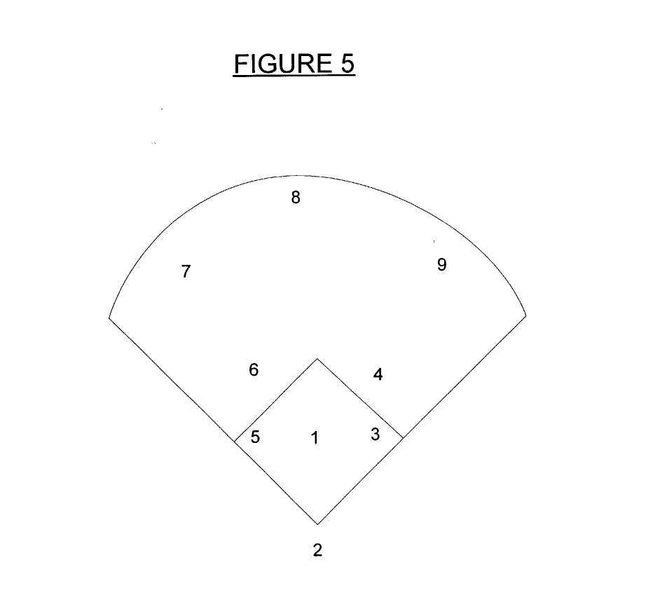

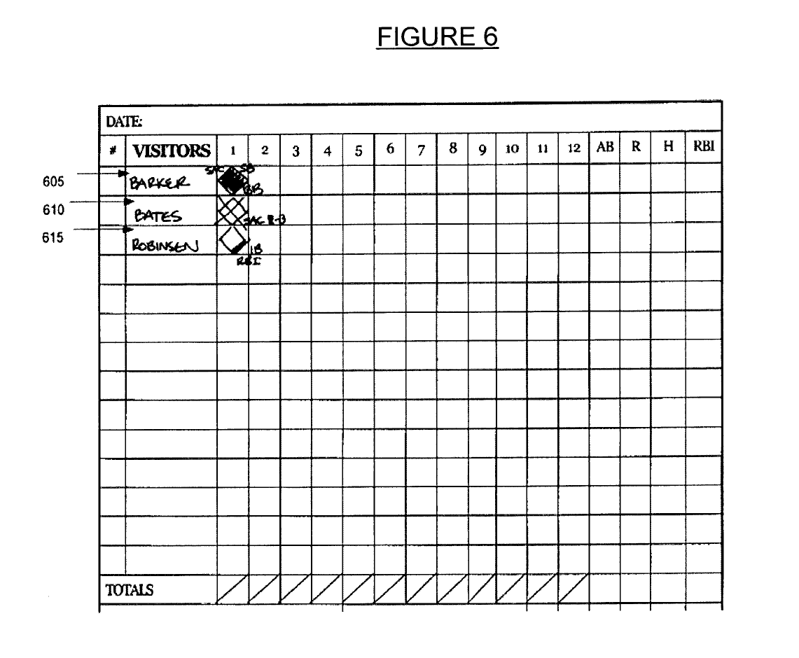

FIGS. 5-6 are charts illustrating an example scoring system, usable in conjunction with an embodiment of the present invention (e.g., via a graphical user interface (GUI) for the hand-held or other user device). Those skilled in the related art will recognize that there are numerous scoring systems for baseball, and other sports. This example of a scoring system is used merely to explain an embodiment of the present invention, and should not be seen as limiting the present invention. Many other scoring methods, for baseball or another sport, can be used in conjunction with the present invention.

Baseball scoring systems typically utilize various symbols and terminology. For example, SAC usually indicates sacrifice bunt, FC usually indicates fielder's choice, and BB usually indicates walk. FIG. 5 is a diagram indicating the numbers traditionally assigned to various positions on a baseball field. For example, 1 indicates pitcher, 2 indicates catcher, 3 indicates first baseman. The terminology and position numbers are used together to score a baseball game. For example, 63 indicates that the batter grounded out and the shortstop threw to 1^{st} base, and 3U indicates that a ground ball was thrown to the 1^{st} baseman who made an unassisted putout.

FIG. 6 is a chart illustrating an example partially completed baseball score card utilizing a basic scoring system on a GUI for a handheld or other user device, in accordance with an embodiment of the present invention. For example, entry 605 indicates that a first player, who is named Barker, walked to 1^{st}, stole 2^{nd} while Bates was batting, moved to 3^{rd} as Bates was out on a sacrifice bunt, and came to home because of Robinsen's single. Entry 610 indicates that the second player, named Bates, hit into a 1-3 sacrifice bunt, meaning to the pitcher, who in turn threw to the 1^{st} baseman, sacrificing Barker to 3^{rd}. Entry 615 indicates that a third player, named Robinsen, singled to right (scoring Barker from 3^{rd}).

Thus, in step 411 of FIG. 4, the user enters scoring information according to the system above, such as by inputting the information by writing with a stylus to a hand-held device, selecting from a pull-down menu, or otherwise inputting via keys or other input devices to a GUI, as is known in the art. The user utilizes the storage mechanism to save the user-recorded scoring information. The user can then access the storage mechanism (e.g., access a disk taken from the hand-held or other user device via a user terminal, or access a server on a network at which information from the hand-held or other user device was saved) to retrieve the information, review game results, recreate the game by reviewing the scoring sheets, and determine the result of certain events on the game (e.g., the impact of player #15 striking out on the result of the game). This information is referred to as the user-scored information.

In addition to inputting information, in an embodiment of the present invention, computer-recorded scoring information mixed with user-recorded scoring information can be utilized by the user (e.g., the user is able to access other non-user recorded game score sheets stored for games the user missed). In this way, if a user is unable to user-record every game, the user is still able to compare games in a season to each other.

The present invention is described in terms of the above embodiments. This is for convenience only and is not intended to limit the application of the present invention. In fact, after reading the description of the present invention, it will be apparent to one skilled in the relevant arts how to implement the present invention in alternative embodiments.

In addition, it should be understood that FIGS. 1-6 described above, which highlight the functionality and advantages of the present invention, are presented for example purposes only. The architecture of the present invention is sufficiently flexible and configurable, such that it may be utilized in ways other than that shown in FIGS. 1-6.

What is claimed is:

1. A method for interactively participating in a sporting event via a user device, the method comprising:
transmitting sporting event related information to the user device;
receiving input information via the user device relating to the sporting event;
storing the received input information; and
providing an option to access the received input information at a remote location.

2. The method of claim 1, wherein the sporting event related information includes player information.

3. The method of claim 1, wherein the sporting event related information includes stadium related information.

4. The method of claim 1, wherein the sporting event related information is transmitted to the user device from a server.

5. The method of claim 1, wherein the sporting event related information is transmitted to the user via a communication device.

6. The method of claim 5, wherein the communication device includes a wireless transmitting and receiving device.

7. The method of claim 1, wherein the sporting event related information is transmitted to the user via a first communication device located at a stadium.

8. The method of claim 7, wherein the sporting event related information is transmitted to the user via a second communication device located remote from the stadium, the second communication device being in communication with the first communication device.

9. The method of claim 1, wherein the user device comprises one selected from a group consisting of a handheld device, a personal data assistant, a mobile telephone device, and a wired device located at a stadium seat.

10. The method of claim 1, wherein the received input information includes scoring information.

11. The method of claim 10, wherein the scoring information is received from a user.

12. The method of claim 1, wherein the sporting event is one selected from a group consisting of a baseball game, a football game, a basketball game, a hockey game, a soccer game, a golf match, a tennis match, and an Olympic event.

13. The method of claim 1, wherein the received information is stored in a repository.

14. The method of claim 13, wherein the repository is located on a storage device.

15. The method of claim 14, wherein the storage device is housed within the user device.

16. The method of claim 14, wherein the storage device is coupled to the user device.

17. The method of claim 13, wherein the repository is located in a removable storage device accessible by the user device.

18. The method of claim 13, wherein the repository is accessed by a server.

19. The method of claim 13, wherein the sporting event related information is transmitted to the user device from a server, and wherein the repository information is housed on the server.

20. The method of claim 17, wherein providing an option to access the received information at a remote location includes:
accessing the removable storage device at a remote location.

21. The method of claim 20, wherein the removable storage device is accessed at a remote location via a terminal.

22. The method of claim 21, wherein the terminal is selected from a group consisting of a personal computer, a minicomputer, a microcomputer, a mainframe computer, a handheld device, and a telephone device.

23. The method of claim 22, wherein the handheld device comprises a personal data assistant.

24. The method of claim 19, wherein the server is coupled to a network, and wherein providing an option to access the received information at a remote location includes:
accessing the server via the network.

25. The method of claim 24, wherein the server is accessed via a remote terminal.

26. The method of claim 24, wherein the network is the Internet.

27. A method for scoring a sporting event, the method comprising:
receiving scoring input via a user terminal;
storing the scoring input; and
providing an option to access the stored scoring input at a remote location.

28. The method of claim 27, wherein the user terminal is selected from a group consisting of a wired device located at a stadium seat, a handheld device, a personal data assistant, and a mobile telephone device.

29. The method of claim 27, wherein the scoring input is received approximately concurrently with scoring events in the sporting event.

30. The method of claim 27, wherein the scoring input is stored in the user terminal.

31. The method of claim 30, wherein the scoring input is stored in the user terminal via a removable storage device, and wherein providing an option to access the scoring input at a remote location includes:
accessing the removable storage device at the remote location.

32. The method of claim 27, wherein storing the scoring input includes:
transmitting the scoring input to a remote server.

33. The method of claim 32, wherein the remote server is coupled to a network, and wherein providing an option to access the scoring input at a remote location includes:
accessing the remote server via the network.

34. A method of communicating, receiving, and storing sports information related to a sporting event, the method comprising:
receiving scoring information from a user;
storing the scoring information; and
providing the user with an option to review the scoring information.

35. The method of claim 34, wherein the communicating is performed by at least one communication device comprising at least one selected from of a group consisting of:
a regional communication device that communicates information to a local communication device;
a national communication device that communicates information to a regional communication device; and
a national communication device that communicates information to a local communication device.

36. The method of claim 34, wherein sports-related information is also communicated.

37. The method of claim 34, further comprising:
providing the user with an option to change the scoring information and review resultant changes in the scoring information.

38. The method of claim 34, wherein the sports-related information includes at least one selected from a group consisting of:
current game information related to the game played at the sports arena;
other game information related to at least one other game played at another sports arena; and
advertising information.

39. The method of claim 38, wherein the current game information comprises at least one selected from a group consisting of:
background information;
team roster information;
scoring information;
weather information;
sports arena information; and
future scheduling information.

40. The method of claim 39, wherein the team roster information comprises at least one selected from a group consisting of:
original roster change information;
roster change information;
disabled list information;
future pitching rosters;
player background information and statistics; and
team background and statistics.

41. The method of claim 38, wherein the other game information comprises at least one selected from a group consisting of:
sports-related information related to a major sports game; and
sports-related information related to a minor sports game.

42. The method of claim 34, wherein the at least one device is accessed by at least one user at a sporting arena.

43. A computer program product comprising a computer usable medium having control logic stored therein for communicating, receiving, and storing sports information related to a sporting event, the product comprising:
first computer readable program code means for receiving scoring information from a user;
second computer readable program code means for storing the scoring information; and
third computer readable program code means for providing the user with an option to review the scoring information.

44. A system for communicating, receiving, and storing sports information related to a sporting event, comprising:
means for receiving scoring information from a user;
means for storing the scoring information; and
means for providing the user with an option to review the scoring information.
